(19) United States
(12) Patent Application Publication
(10) Pub. No.: US 2008/0212416 A1
(43) Pub. Date: Sep. 4, 2008

(54) NOTIFICATION DEVICE AND METHOD FOR PROGRAMMING A NOTIFICATION DEVICE

(76) Inventors: Roland Polonio, Neckarsulm (DE); Hans-Joachim Sailer, Heilbronn (DE)

Correspondence Address: Muncy, Geissler, Olds & Lowe, PLLC, P.O. BOX 1364, FAIRFAX, VA, 22038-1364, US

(21) Appl. No.: 11/962,073

(22) Filed: Dec. 20, 2007

Related U.S. Application Data
(60) Provisional application No. 60/876,527, filed on Dec. 22, 2006.

(30) Foreign Application Priority Data
Dec. 20, 2006 (DE) DE 102006060927

(51) Int. Cl. G04G 13/02; G04B 47/00

(52) U.S. Cl. 368/244; 368/10

(57) ABSTRACT

A notification device with a time signal receiver is provided that has a receiver for receiving an electromagnetic time signal and processor for processing the time signal and is assigned a signal output device to generate a warning signal, and to a method for programming a notification device comprising a time signal receiver. In the notification device the time signal receiver and/or the signal output device can be set up to generate a warning signal when there is at least one piece of additional information transmitted with the time signal.

This nonprovisional application claims priority to German Patent Application No. DE 102006060927, which was filed in Germany on Dec. 20, 2006, and to U.S. Provisional Application No. 60/876,527, which was filed on Dec. 22, 2006, and which are both herein incorporated by reference.

### BACKGROUND OF THE INVENTION

1. Field of the Invention

The present invention relates to a notification device with a time signal receiver, which has receiving means for receiving an electromagnetic time signal, and processing means for processing the time signal and is assigned a signal output device to generate a warning signal, and to a method for programming a notification device, comprising a time signal receiver.

2. Description of the Background Art

A notification device can be made as an alarm clock with a radio-controlled clockwork, with a time display and the generation of an optical or audible alarm signal depending on a time signal received and processed by the time signal receiver.

The provision of precise time information is of basic importance for many applications in daily life. In various countries such as the USA, Japan, Russia, Germany, etc., precise time signals, which can be received by suitable receivers (time signal receivers), are provided by the appropriate national organizations. The time signals can be used for further processing, i.e., for the extraction of precise time information in appropriately equipped end devices, particularly in radio-controlled clocks or time-based measuring devices.

Radio waves, particularly in the long-wave frequency range from about 30 kHz to about 300 kHz, are a suitable medium for transmitting time signals. In the case of long-wave signals, particularly by amplitude modulation, encoded time signals have a very broad transmission range; they penetrate into buildings and can still be received with very small ferrite antennas. Obstacles such as trees and buildings cause high signal attenuation in the case of high-frequency satellite signals, but such obstacles have only a slight impact on the reception of long-wave signals.

The time signal is provided by a time signal transmitter, which transmits a signal sequence according to a predefined protocol. The national time signal transmitters differ both in the selected transmission frequency and in the configuration of the protocol. An example of a time signal transmitter is the long-wave transmitter DCF77 managed by the Physikalisch Technische Bundesanstalt (PTB) [Federal Physical and Technical Institute], which is controlled by several atomic clocks and transmits a time signal with a power of 50 KW at the frequency of 77.5 kHz during continuous operation. A more detailed description of the protocol for the time signal transmitted by the DCF77 station can be derived from the description provided hereinafter of FIGS. 1 and 2. Examples of other time signal transmitters are WWVB (USA), MSF (Great Britain), JJY (Japan), and BPC (China), which transmit time information on a long-wave frequency within the range between 40 and 160 KHz by means of amplitude-modulated signals.

In general, to transmit time information, a time signal is transmitted within a time frame which is precisely 1 minute long. This time frame contains values for the minute, hour, calendar day, day of the week, month, year, etc., in the form of BCD codes (binary coded decimal codes), which are transmitted with a pulse duration modulation at 1 Hz per bit. In this case, either the rising or falling edge of the first pulse of a time frame is synchronized precisely with 0 seconds. A typical radio-controlled clock is made so that the setting of time occurs by receiving of the time information of one or a plurality of time frames from the point in time onward at which the zero second signal was first received.

FIG. 1 shows the coding scheme, designated by the reference character A, of the coded time information according to the protocol of time signal transmitter DCF77. The coding scheme in the present case incudes 59 bits, each 1 bit corresponding to a second of the time frame. Over the course of a minute, a so-called time signal telegram, containing information on the time and date in binary coded form, can be transmitted therewith. The first 15 bits B contain a general coding, for example, operating information, and are not used at present. The next 5 bits C contain general information. The letter R designates the antenna bit, and A1 designates an announcement bit for the transition from Central European Time (MEZ) to Central European Summer Time (MESZ) and back again. Z1 and Z2 designate time zone bits. A2 designates an announcement bit for a switching second and S designates a start bit for the encoded time information. Starting with bit 21 and up to bit 59, the time and data information are transmitted with a BCD code, whereby the data apply respectively to the next minute. The bits in area D contain information on the minute, in area E information on the hour, in area F information on the calendar day, in area G information on the day of the week, in area H information on the month, and in area I information on the calendar year. This information is provided in a bit-by-bit fashion in an encoded form. So-called test bits P1, P2, P3 are provided respectively at the ends of areas D, E, and I. The sixtieth bit is vacant and serves to indicate the start of the next frame. M designates the minute mark and thus the start of the time signal.

The structure and bit allocation of the coding scheme, shown in FIG. 1, for transmitting time signals are generally known and described, for example, in an article by Peter Hetzel, “Time Information and Normal Frequency,” Telekom Praxis, Vol. 1, 1993.

The time signal information is transmitted amplitude modulated with the aid of individual second markers. The modulation comprises a reduction X1, X2 or increase in the carrier signal X at the beginning of each second, whereby at the beginning of each second—with the exception of the fifty-ninth second of each minute—in the case of a time signal transmitted by the DCF77 transmitter, the carrier amplitude is reduced for 0.1 seconds X1 or for 0.2 seconds X2 to about 25% of the amplitude. These reductions of different duration each define a second marker or databit. This different duration of the second markers is used for the binary coding of the clock time and date, whereby second markers X1 with a duration of 0.1 seconds correspond to the binary “0” and those X2 with a duration of 0.2 seconds to the binary “1.” The absence of the sixtieth second marker announces the next minute marker. An evaluation of the time information sent by the time signal transmitter may then be performed in combination with the respective second. Using an example, FIG. 2 shows a section of this type of amplitude-modulated time signal, in which the encoding occurs by a reduction of the HF signal with a different pulse length.

Conventional time signal receivers, as they are described, for example, in the German Patent DE 35 16 810 C2, receive the amplitude-modulated time signal emitted by the time signal transmitter and output it again demodulated as variably long pulses. This occurs in real time; i.e., a variably long pulse is generated per second at the output corresponding to the idealized time signal according to FIG. 2. In this case, the time information is thereby available encoded by the variably long pulses of the carrier. These pulses of different length are supplied by the time signal receiver to a microcontroller connected downstream. The microcontroller evaluates these pulses and determines whether corresponding to the length of this pulse a bit value of “1” or “0” is assigned to the specific pulse. This occurs by determining first the second beginning of a particular time frame of the time signal. If this second beginning is known, the bit value “1” or “0” can then be determined each time from the determined duration of the pulse. The microcontroller now takes up in sequence all 59 bits of a minute and based on the bit encoding of a specific second pulse determines which precise time and which precise date are present.

Precise time information can be provided thereby with the aid of this type of time signal receiver in the notification device. Moreover, a time-dependent provision of a signal, for example, an audible or optical signal, can be realized in conjunction with the signal output device.

### SUMMARY OF THE INVENTION

It is therefore an object of the present invention to provide a notification device and a method for programming a notification device, which enable an expansion of a range of functions of a prior-art notification device.

According to a first aspect of the invention, a time signal receiver and/or a signal output device is/are set up to generate a warning signal when there is at least one piece of additional information transmitted with the time signal. In other words, a warning signal, particularly specifically pronounced with respect to its frequency and/or modulation, of the signal output device is output when there is additional information in the time signal.

This type of additional information concerns one or more bits, which are not provided according to the coding of the time signal for transmission of time information. In the case of a time signal according to the protocol of time signal transmitter DCF77, bits 1 to 15 can be used to transmit this type of additional information, because these bits are not needed for transmitting the time information. If there are a larger number of free bits in the time signal, the warning notification to be transmitted can be encoded, so that a multidigit code can be transmitted in the time signal according to a predefinable protocol, stored in the time signal receiver. In the case of other time signals, which have only one free bit or only a few free bits, it can be provided that the time signal receiver, upon arrival of the additional information encoded in the bit or in the few bits, is switched to an internally stored warning notification protocol for decoding other information, no longer transmitted in the time signal protocol.

The warning signal can be defined, for example, as a disaster warning signal, which is transmitted via the time signal transmitter in the case of a general threat to the population. The warning signal is output by the appropriately equipped notification devices in particular with a predefinable tone frequency, tone sequence, and/or a predefinable rhythm in order to encode different warnings.

An embodiment of the invention provides that at least one selection criterion, provided for blocking or releasing control of the signal output device, is stored in the time signal receiver and/or in the signal output device. The selection criterion can be one or more parameters, which define the predefinable target groups for the warning signals. For example, a selection criterion can be directed to a federal state or to a geographic or administrative region such as a county. The achieved result here can be that additional information contained in the time signal optionally leads to the actuation of the warning signal only regionally or locally, whereas in other regions notification devices with a different coding of the selection criterion emit no warning signal despite the additional information contained in the time signal, because this is blocked by the selection criterion. The selection criterion can be stored either fixedly in the layout of the time signal receiver or the signal output device; setting via an external coding such as a plug (jumper) which can be plugged in variably on a strip or an arrangement of several switches (DIP switches) is also possible.

Another embodiment of the invention provides that the receiving means and/or processing means are assigned memory means, configured for temporary storage of the selection criterion. The memory means enable a flexible adjustment of the notification device to a user. For example, a notification device produced as a mass product can be programmed when purchased in the retail store in such a way that it receives data stored in the memory means about the future site of use, e.g., the user's home or workplace. For example, the supplying of a zip code or other regional coding in the memory means is conceivable to assure that a warning signal is output by the notification device only when the region is affected by a corresponding warning. As a supplement or alternatively, an occupational or volunteer activity of the future user, for example, as a physician or disaster response worker, can also be stored in the memory means to enable the alerting of certain occupational groups. A combination of selection criteria of this type can also be stored in the memory means to achieve the most accurate adaptation possible to a user profile.

Another embodiment of the invention provides that the receiving means and/or processing means are set up to derive programming instructions, in particular an encoded selection criterion, from the time signal and/or from a wirelessly transmitted programming signal and to store the programming instructions in the memory means. In other words, a programmable time signal receiver is proposed, which has receiving means for the wireless receiving of an electromagnetic time signal and/or a programming instruction and processing means for processing the time signal and/or programming instructions, whereby the receiving means and/or processing means are assigned memory means, configured for temporary storage of programming instructions and for supplying the instructions to the receiving means and/or to the processing means, whereby the receiving means and/or processing means are set up to derive programming instructions from the time signal and/or from a programming signal and to store the programming instructions in the memory means. The programming signal here is a programming device signal encoded with a plurality of programming instructions and based on a programming protocol different from the time signal protocol.

It is provided in another embodiment of the invention that the time signal receiver has frequency switching means, which are formed to supply at least two different clock frequencies for the time signal receiver. The frequency switching means enable switching between the operating clock frequency and the programming clock frequency depending on a programming signal supplied by the programming device and therefore adjustment of the time signal receiver to different data rates during the receiving of a time signal or of programming instructions.

Another embodiment of the invention provides that at least one internal clock generator is assigned at least two frequency dividers, which are controllable by the frequency switching devices and have different divider ratios. With the two frequency dividers, optionally the lower operating clock frequency or the higher programming clock frequency can be supplied to the time signal receiver via control by means of the frequency divider control device. The frequency switching device can be set up preferably in such a way that it conducts the basic clock frequency generated by the internal clock generator, depending on the presence or absence of the programming signal, to one or the other of the at least two frequency dividers. Both frequency dividers in turn are connected to the receiving means and/or the processing means and/or the memory means to supply the particular clock signal to these devices. A combination of several internal clock generators is also conceivable, whereby at least one of the internal clock generators is assigned at least two frequency dividers, so that in all at least three different clock frequencies can be provided.

Another embodiment of the invention provides that an internal clock generator is assigned a frequency divider adjustable by the frequency switching device variably to different divider ratios. A variably adjustable frequency divider can be formed for supplying a continuously tunable clock frequency or for supplying different but fixedly predefined divider ratios and clock frequencies linked therewith. Preferably, the frequency divider is designed to realize a simple structure of the time signal receiver to supply at least two different but fixedly predefined clock frequencies.

Another embodiment of the invention provides that the frequency switching device is set up for switching between an external, wired or wirelessly coupled programming clock frequency and an internal operating clock frequency supplied by the internal clock generator. Coupling of an external programming clock frequency into the time signal receiver is enabled thereby. The frequency switching device is configured so that collision of the externally wired or wirelessly coupled programming clock frequency with the internal operating clock frequency is avoided.

Another embodiment of the invention provides that control means are provided, which are configured to output a programming control signal supplied by the receiving means and/or by the processing means and/or by the memory means. The programmable time signal receiver of the invention has receiving means for receiving an electromagnetic time signal and a programming signal, as well as processing means for processing the time signal and the programming signal, whereby the receiving means and/or processing means are assigned memory means, configured for temporary storage of programming instructions and for supplying the programming instructions to the receiving means and/or to the processing means. In addition, control means are provided, which are configured to supply a programming control signal supplied by the receiving means and/or by the processing means and/or by the memory means. The programming control signal is output to confirm a successful run of a programming process and therewith enables a check whether the programming instructions supplied by a programming device were successfully decoded and optionally processed.

It is provided in an embodiment of the invention that the control means are set up for wireless transmission of the programming control signal, particularly at a frequency of the time signal and/or the programming signal. Feedback from the time signal receiver to the programming device can be realized as a result in a simple manner without the need for electric or electromechanical coupling between the time signal receiver and the programming device. In an advantageous embodiment of the invention, it is provided that the programming control signal is transmitted to the programming device at the frequency at which the time signal and/or the programming signal is/are transmitted. This is an advantage because the programming device is designed in any event for processing signals with this (these) frequency (frequencies) and thereby no additional devices are necessary for receiving the programming control signal.

It is provided in another embodiment of the invention that the control means are set up for wireless transmission of the programming control signal by means of the receiving means, particularly by means of an antenna device assigned to the receiving means. An especially efficient feedback of a programming control signal to the programming device can be brought about by using the receiving means of the time signal receiver, which are set up in any event for processing time signals and programming signals. The receiving means are optimized in their design or their layout to the frequency of the time signal and the programming signal. Thus, for wireless output of the programming control signal during use of the receiving means, only a minimum amount of power is required, because good efficiency of programming control signal transmission is assured by the optimization of the receiving means. Because time signal receivers are often provided for operation with batteries or similar power storage devices with a limited power capacity, the programming control signal can be output with low power consumption by using the receiving means.

Another embodiment of the invention provides that the control means have switching means, which are configured to supply the programming control signal to an antenna device depending on a switching signal. A high-impedance switching signal, which is supplied by processing means configured as a state machine, particularly as a microcontroller, can be converted with the switching means into a programming control signal transmitted by the antenna device.

According to a second aspect of the invention, a household appliance, particularly a smoke alarm, is provided which has at least one functional unit for providing a useful function and an additionally provided notification device. The household appliance can be, for example, a smoke alarm, which is provided with a functional unit formed as a smoke detector, or a washing machine, coffee maker, a microwave oven, etc. Such household appliances, typically permanently connected to the mains supply, such as, for example, the washing machine or the microwave oven, are preferably provided with an additional notification device and/or in any event provided with a signal output device, as is the case, for example, with smoke alarms. The time signal receiver in the notification device can also be used to control a radio-controlled clock for the corresponding household appliance, but this type of utilization is not absolutely necessary.

According to another aspect of the invention, a method is provided for programming a notification device with the following steps: provision of at least one programming instruction to the notification device, particularly to a time signal receiver in the notification device, by means of a programming device; decoding of the programming instruction by the receiving means and/or by the processing means of the notification device; and storage of the programming instruction, designated for execution in the receiving means and/or in the processing means, in the memory means of the notification device. Here, both wired and wireless transmission of the programming instructions from the programming device to the notification device can be provided.

Another embodiment of the invention provides that the programming instructions are transmitted wirelessly by the programming device to the notification device, particularly to the time signal receiver. The method of the invention for wireless programming of a time signal receiver comprises the following steps: transmitting a programming instruction, which is encoded in a data format adapted to a time signal receiver, by a transmitting device; wireless receiving of the programming instruction by the receiving means of a time signal receiver, which is set up to receive a time signal according to a predefinable time signal protocol; decoding of the programming instruction by the receiving means and/or by the processing means of the time signal receiver; and storage of the programming instruction, designated for execution in the receiving means and/or in the processing means, in a memory means of the time signal receiver. Simultaneous programming of a plurality of time signal receivers is possible by the method of the invention, because the programming instructions are transmitted without mechanical contact between a programming device and the time signal receiver. It is therefore possible to realize programming of a time signal receiver also during mass production, without an uneconomically large number of programming devices being necessary for this. Moreover, contact areas for wired coupling of the programming instructions can be eliminated, as a result of which simplification of the time signal receiver can be realized. It is possible in addition to program the time signal receiver without direct mechanical access also after integration into a more complex unit, for example, into a measuring device or into a household appliance.

An updating of programming instructions at a later time after completion of the time signal receiver is also conceivable. It is critical that for the programming of the time signal receiver the access provided for the reception of the time signal is used, to effect a wireless or contactless transmission of programming instructions. To carry out the method, a programming instruction, written in a format decodable by the time signal receiver, is made available to the time signal receiver. By means of a first programming instruction, the time signal receiver can be made ready to receive additional programming instructions. The receiving means of the time signal receiver are in particular an analog receiver arrangement, as described in the Unexamined German Patent Application No. DE 103 34 990, which corresponds to U.S. Publication No. 2005/0036514, and which is incorporated herein by reference. The processing means can be made, for example, as a state machine or as a microcontroller. The processing means are assigned internally integrated or separately made memory means for storing at least one program instruction.

An embodiment of the invention provides that to program the time signal receiver, at least one complete time signal is transmitted according to the time signal protocol, which in addition comprises a number of programming instructions. In this type of procedure, which can be used in particular for the time signal of the German DCF77 transmitter, transmission of programming instructions is possible without the transmission of the time signal having to be eliminated. According to the protocol of the DCF77 time signal, the first 15 bits are freely available within the time frame, which in the case of DCF77 has a duration of 60 seconds, and can therefore be used for transmitting a first programming instruction (first bit in the DCF77 protocol), serving as a programming status signal, and for transmitting other programming instructions (2nd to 15th bit in the DCF77 protocol). Therefore, programming of the time signal receiver and synchronization of the time signal receiver to the time signal transmitted for programming can be performed simultaneously. After a programming phase is completed, therefore, the full functionality of the time signal receiver including the capability for correct synchronization to the time signal can be checked immediately. The disadvantage of a low data rate for programming instruction transmission within the scope of the time signal (in the case of the DCF77 protocol 14 usable bits per minute), which can take several minutes, is easily lessened by the fact that a plurality of time signal receivers can be programmed wirelessly simultaneously by a single programming device.

Another embodiment of the invention provides that to program the time signal receiver, in a first step a time signal is transmitted, which comprises at least one programming instruction for switching the time signal receiver to a programming protocol, and that in other steps programming instructions are transmitted according to a programming protocol stored in the time signal receiver. This type of procedure may be used when the time signal receiver is provided for a time signal protocol in which only a few bits or even only one bit is freely available, as is the case in most time signal protocols. For programming, a time signal is first made available to the time signal receiver according to the respective protocol, in which at least one free bit is set according to a protocol stored in the time signal receiver so that during the decoding in the time signal receiver it can be recognized that a programming process is planned. The time signal receiver switches to a programming state upon arrival of the appropriate bit. In the programming state, the programming device uses a from the time signal protocol different programming protocol that is stored in the time signal receiver for decoding the programming instructions.

Another embodiment of the invention provides that to program the time signal receiver, programming instructions are transmitted in a programming protocol different from the time signal and stored in the time signal receiver. The time signal receiver can be set up in such a way that it examines the incoming signals to determine whether they are time signals or programming instructions. The time signal receiver can also be set up in such a way that it is switched to the programming state by means of a parameter linked to the time signal, for example, by means of the field strength of the time signal, or by a parameter independent of the time signal, for example, by a programming status signal sent by the programming device. A preferred embodiment of the invention provides that the programming signal for switching to the programming state is derived from the time signal field strength. The variable amplification of the adjustable amplifier provided in the receiving means can be used in particular in this case. An incoming signal with a high field strength is detected based on a minimal amplification and indicates to the time signal receiver that programming with a programming device is to be carried out.

Another embodiment of the invention provides that the time signal receiver upon receiving the programming instruction is switched to the programming state for a predefinable time period. This assures that the time signal receiver always enters the receive state for the time signal also if the programming process is not fully completed.

Another embodiment of the invention provides that the time signal receiver is switched to the programming state when the programming instructions are received until a reset instruction arrives. As a result, a variable number of programming instructions can be transmitted to the time signal receiver. Upon arrival of the reset instruction, the time signal receiver switches back to the receive state for the time signal and can be tested, for example, immediately after the programming process for its reception properties for the time signal. This is an advantage, when different production batches of time signal receivers are to be programmed with very different amounts of programming instructions. When the number of programming instructions to be transmitted is low, the function test with the time signal can be performed even after a short time. When there are many programming instructions, switching back to the receive state occurs only after they are all transmitted.

Another embodiment of the invention provides that release or blocking of functions, fixedly predefined in the time signal receiver, is performed in the programming state. The functions are provided in the layout, i.e., in the hardware of the time signal receiver, and can be blocked or released by using internal pointers, i.e., by software. In carrying out the programming process, the particular pointers are set in accordance with the specification by the programming device and thereby determine the range of functions of the time signal receiver. A typical use for such releasable and blockable functions are stopwatch or calendar functions in a wristwatch with a radio-controlled clockwork. In the radio-controlled clockwork these functions are all applied on the hardware side and depending on the wristwatch model are released or blocked on the software side by wireless programming.

In an embodiment of the invention, a final blocking of the programming state is specified after a single programming run. This type of blocking can be brought about particularly by setting of an internal pointer in the receiving means or in the processing means or by separating one or more electrical connections in the time signal receiver, for example, by a signal with a high field strength radiated in from outside. This prevents a subsequent change of the program instructions transmitted during the programming process, which is of particular interest in the setting of different ranges of functions for the time signal receiver.

It is provided in another embodiment of the invention that in the programming state a freely programmable instruction sequence, designated for execution by the receiving means and/or processing means, is stored in the memory means. With a freely programmable instruction sequence, functions can be implemented in the time signal receiver, which are not already stored in the layout of the time signal receiver. These can be, for example, country-specific parameters for decoding the time signal or extra software, which is to run in the time signal receiver.

It is provided in another embodiment of the invention that the programming instructions are supplied at a data rate that is selected higher than the data rate of a time signal, whereby the time signal receiver is supplied with a programming clock frequency which is adjusted to the data rate and is selected higher than the internal operating clock frequency of the time signal receiver. The method of the invention for increasing the programming rate for a time signal receiver comprises the following steps: provision of a programming clock frequency that is greater than an internal operating clock frequency of the time signal receiver to the time signal receiver; provision of programming instructions to the time signal receiver by means of a programming device at a data rate adjusted to the programming clock frequency; decoding of the programming instructions by the receiving means and/or by the processing means of the time signal receiver, particularly in the clock of the programming clock frequency; and storage of the programming instruction, designated for execution in the receiving means and/or in the processing means, in the memory means of the time signal receiver, particularly in the clock of the programming clock frequency. The desired acceleration of the programming process is achieved in that the internal processing speed of the time signal receiver, which is designed for the low data rate of the time signal and for low power consumption, is overridden by means of the programming clock frequency and thereby increased. For the time signal receiver, adjustment to a higher data rate is therefore achieved by which appropriate programming instructions can be supplied at a higher speed by the programming device, with the aid of the programming clock frequency, which is selected higher than the internal operating clock frequency. It is possible to achieve halving of the programming time even at a programming clock frequency that is selected twice as high as the operating clock frequency. This is of particular interest when many time signal receivers are to be programmed during mass production. A short programming time is also desired, when programming of a time signal receiver that is provided in an end user device, such as a wristwatch, a household appliance, or another device, is to occur with end-customer-specific data, for example, at the cash register in a retail store. The programming clock frequency is preferably selected so that an advantageous compromise between a short programming time and a reliable run of the programming process is assured. Due to its structure or its layout, the time signal receiver does not permit any desired increase in the operating clock frequency. Preferably, at least a doubling, especially preferably a quadrupling, particularly a tenfold increase, of the operating clock frequency is provided.

It is provided in an embodiment of the invention that the programming clock frequency is derived from a clock frequency supplied internally in the time signal receiver, particularly by an internal clock generator. The operating clock frequency of a time signal receiver is typically derived from a considerably higher basic clock frequency. In a prior-art time signal receiver, an internal clock generator, made as a quartz oscillator, supplies a frequency of about 32 kHz, which is divided down with use of frequency dividers to an internal operating clock frequency of 1024 Hz. The receiving means and/or the processing means and/or the memory means are operated at the operating clock frequency. A higher internal clock frequency can be supplied in a simple way by using a lower divider ratio to the basic clock frequency and is then used as the programming clock frequency for transmitting programming instructions at a higher data rate. Problems such as supplying and transmitting an external programming clock frequency to the time signal receiver are eliminated by using an internal clock frequency.

Another embodiment of the invention provides that a programming signal, supplied by the programming device, causes a switching of a frequency switching device assigned to the time signal receiver from the operating clock frequency to the programming clock frequency. The frequency switching device can be provided for different control of an arrangement of frequency dividers, which are cascaded, i.e., connected in series, depending on a programming signal. In this case, in the absence of a programming signal, the frequency divider is controlled in such a way that the basic clock frequency is divided down to the operating clock frequency. Provided that the programming clock signal is present, one or more frequency dividers are controlled by the frequency switching device in such a way that they cannot undertake further division of the basic clock frequency, so that a higher clock frequency can be output. Alternatively, the clock frequency is decoupled from the frequency switching device before all frequency dividers of a frequency divider arrangement are run through, in order to obtain a clock signal with a higher clock frequency. In another embodiment of the invention, the frequency switching device is provided for switching between two or more internal clock generators, whose basic clock frequencies, different from one another, are conducted alternatively via the one frequency divider device in order to supply the operating clock frequency or the programming clock frequency.

Another embodiment of the invention provides that switching is brought about from a first frequency divider, which has a higher divider ratio, to a second frequency divider, which has a lower divider ratio, with the programming signal in the frequency switching device. A simple construction of the time signal receiver can be realized thereby, because it is not the frequency dividers that are made switchable, but rather a suitable introduction of the supplied basic clock signal occurs from the frequency switching device to the first or second frequency divider.

Another embodiment of the invention provides that the programming clock frequency is supplied by the programming device. In this way, the provision of different internal clock generators, frequency dividers, or frequency switching devices can be eliminated in the time signal receiver, so that an especially economical construction of the time signal receiver is assured. Rather, the programming clock signal is fed from outside into the time signal receiver in such a way that an overriding of the operating clock signal occurs and the programming can occur at a higher data rate.

Another embodiment of the invention provides that the programming clock frequency is transmitted wirelessly by the programming device to the time signal receiver. In this way, a plurality of time signal receivers can be supplied simultaneously with the programming clock signal for rapid execution of the programming. This applies particularly when the programming instructions are also transmitted wirelessly by the programming device to the time signal receiver.

Another embodiment of the invention provides that the programming clock frequency is transmitted in a wired manner by the programming device to the time signal receiver. Individual adjustment of the programming clock frequency and the data rate of the programming instructions to the boundary conditions of the time signal receiver is made possible particularly in combination with wired transmission of the programming instructions to the time signal receiver. Feedback of information, e.g., a status signal, from the time signal receiver to the programming device can be realized by means of wired information transmission (programming clock frequency and/or programming instructions) between a programming device and time signal receiver without additional devices at the time signal receiver. This type of feedback enables, for example, the supplying of information on whether the programming instructions fed in at a predefined data rate to the time signal receiver were completely and correctly decoded and processed. Thus, dynamic adjustment of the programming clock frequency can be made without additional devices at the time signal receiver, so that an average duration of the programming processes can be optimally adjusted for a larger number of similar time signal receivers to be programmed, whereby an additional saving of time can be realized.

Another embodiment of the invention provides that during and/or after the programming process, a programming control signal can be output by the time signal receiver to the programming device. The following steps are therefore provided: provision of at least one programming instruction to a time signal receiver by means of a programming device; decoding of the programming instruction by the receiving means and/or by the processing means of the time signal receiver, storage of the programming instruction, designated for execution in the receiving means and/or in the processing means, in the memory means of the time signal receiver; outputting of a programming control signal during and/or after the programming process by means of the time signal receiver; and receiving and processing of the programming control signal in the programming device. By means of this type of method, feedback of the time signal receiver can be transmitted to the programming device, which provides information whether the programming process triggered by the programming device in the time signal receiver is being or was carried out successfully. This is of particular interest when data that are to control security-relevant functions of the time signal receiver are transmitted with the programming instructions to the time signal receiver. For this case, it can also be provided that the time signal receiver transmits the data in a processed, particularly encrypted, form back again to the programming device, so that precise control of the transmitted data is possible. The programming control signal can be output after each programming instruction, preferably after a sequence of programming instructions of predefinable length, especially preferably after the end of the programming process.

It is provided in another embodiment of the invention that the programming instructions are supplied at a data rate that is selected higher than the data rate of the time signal, whereby the time signal receiver is supplied with a programming clock frequency which is adjusted to the data rate and is selected higher than the internal operating clock frequency of the time signal receiver. As a result, acceleration of the programming process is made possible in that the internal processing speed of the time signal receiver, which is designed for the low data rate of the time signal and for low power consumption, is overridden by means of the programming clock frequency and thereby increased. For the time signal receiver, adjustment to a higher data rate is therefore achieved by which appropriate programming instructions can be supplied at a higher speed by the programming device, with the aid of the programming clock frequency, which is selected higher than the internal operating clock frequency. It is possible to achieve halving of the programming time even at a programming clock frequency, which is selected as twice as high as the operating clock frequency. This is of particular interest when many time signal receivers are to be programmed during mass production. A short programming time is also desired, when programming of a time signal receiver, which is provided in an end user device, such as a wristwatch, a household appliance, or another device, is to occur with end-customer-specific data, for example, at the cash register in a retail store. The programming clock frequency is preferably selected so that an advantageous compromise between a short programming time and a reliable run of the programming process is assured. Due to its structure or its layout, the time signal receiver does not permit any desired increase in the operating clock frequency. Preferably, at least a doubling, especially preferably a quadrupling, particularly a tenfold increase, of the operating clock frequency is provided.

The programming control signal provides the possibility of monitoring the programming process and, in the event of faulty programming, to carry out a reduction in the programming clock frequency and the programming data rate to assure a reliable programming result.

It is provided in another embodiment of the invention that in sequential programming processes a subsequent programming process is carried out with a programming clock frequency that is selected higher than a programming clock frequency of a preceding programming process, provided the previous programming process was carried out properly. Determination of an optimal programming speed for the time signal receiver can be performed therewith over many successive programming processes. This is of interest in the mass production of time signal receivers, because different batches of time signal receivers can differ due to variation in the production processes also with respect to their maximum programming speed or maximum data rate and therewith dynamic adjustment of the programming clock frequency to the properties of the time signal receiver is possible. If a time signal receiver to be programmed next cannot be successfully programmed with the preceding programming clock frequency, the programming clock frequency and the data rate are reduced for the programming instructions.

Another embodiment of the invention provides that the programming clock frequency is supplied by the programming device. This makes it possible to supply several programming clock frequencies with a minor frequency difference, so that an advantageous adjustment to the properties of the time signal receiver can be realized without corresponding devices having to be provided for this in the time signal receiver.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic graphic depiction of a time signal, which is encoded according to the protocol of the time signal transmitter DCF77;

FIG. 2 shows part of an idealized time signal with 5 second pulses;

FIG. 3 shows a block diagram of a time signal receiver in greatly simplified form;

FIG. 4 shows a detailed block diagram of part of the time signal receiver according to FIG. 3;

FIG. 5 shows a schematic drawing of a programming device for a plurality of time signal receivers according to an embodiment of the invention;

FIG. 6 shows a schematic drawing of a wired programming device, which is set up for supplying an external programming clock signal;

FIG. 7 shows a schematic drawing of a programming device for wireless transmission of programming instructions and a time signal receiver adjusted thereto;

FIG. 8 shows a schematic drawing of a programming device, which is set up for wireless supplying of an external programming clock signal and for receiving a programming control signal; and

FIG. 9 shows a schematic drawing of a control device for wireless transmission of a programming control signal.

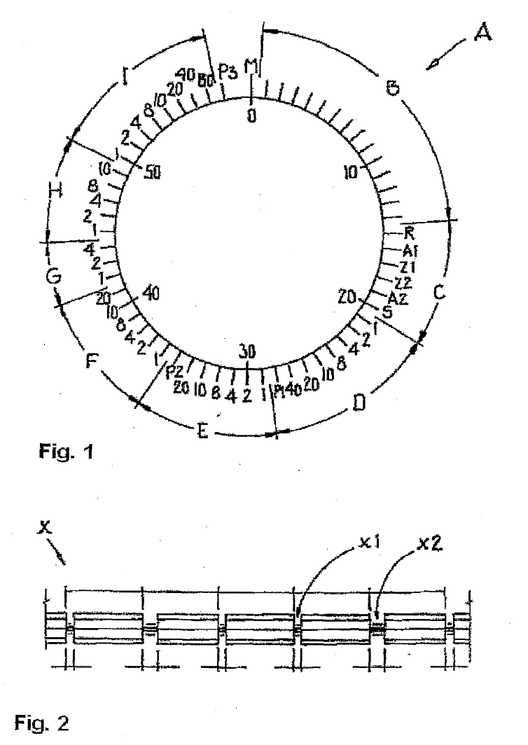

### DETAILED DESCRIPTION

The same or functionally equivalent elements, signals, and functions, if not indicated otherwise, are designated with the same reference characters in all figures of the drawing.

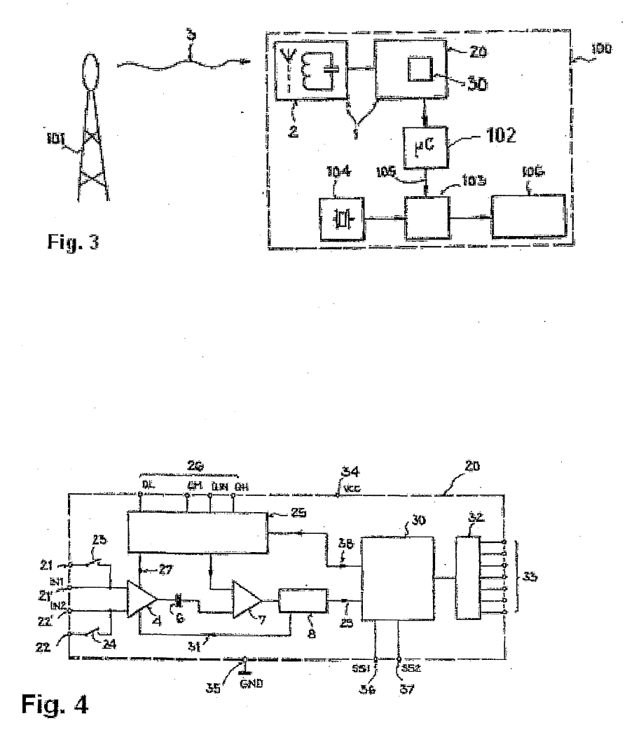

The basic structure and operating mode of a time signal receiver are known from German Patent DE 35 16 810, which is incorporated by reference herein. FIG. 3 shows a block diagram of a greatly simplified time signal receiver, which is formed in the present case as radio-controlled clock 100. Radio-controlled clock 100 has an antenna 2 for picking up time signal 3 transmitted by a time signal transmitter 101. An integrated circuit 20 with a logic and control unit 30 is connected to antenna 2. Antenna 2 and integrated circuit 20 together form receiver 1. A program-controlled unit, made as microcontroller of 102 in the form of processing means, is connected downstream of the outputs of receiver 1. Microcontroller 102 takes up the databits generated by the receiver, calculates a precise time and date from these, and generates therefrom a signal 105 for the time and date. In addition, radio-controlled clock 100 has an electronic clock 103 whose time is controlled by a clock crystal 104. Electronic clock 103 is connected to an indicator 106, for example, a display, by which the time is displayed.

FIG. 4 shows the time signal receiver part, made as integrated circuit 20, using a detailed block diagram. Integrated circuit 20 has two inputs 21, 22 for connection to one or two antennas, which are not shown. By providing two or more antennas, it is possible to tune receiver 1 to different time signal transmitters, which operate in different wavelengths ranges, by switching between the antennas. A frequency switch or antenna switch can be made with the switching. A control amplifier 4 can be connected to one of the antenna inputs 21, 22 by controllable switches 23, 24. The other input of control amplifier 4 is connected to inputs 21′, 22′. A reference signal IN1, IN2, for example, can be coupled into these inputs. Control amplifier 4 is connected on the output side to an input of a postamplifier 7. A filter 6, which is formed as a capacitor and with which parasitic capacitances between inputs QL-QH can be compensated, is disposed in-between.

Integrated circuit 20 further has a switching unit 25. Switching unit 25 has, for example, a plurality of switchable filters at inputs QL-QH, by means of which switching unit 25 is designed to provide several frequencies on the output side. These frequencies can be set via control inputs 26, 36, 37 of switching unit 25. Control amplifier 4 can be influenced, particularly controlled, by control signal 27 supplied by switching unit 25. Switching unit 25 further generates an output signal 28, which is coupled into a second input of postamplifier 7. Postamplifier 7 controls rectifier 8 connected downstream. Rectifier 8 generates a control signal 31 (AGC signal=Automatic Gain Control), which controls control amplifier 4. Rectifier 8 on the output side further generates an output signal 29, for example, a rectangular output signal 29 (TCO signal), which is supplied to a logic and control unit 30 connected downstream.

Logic and control unit 30 is connected to an input/output device 32 (I/O unit), which is connected to input/output terminals 33 of integrated circuit 20. At these terminals 33, the time signals processed, decoded, and stored, among others, in logic and control unit 30 can be tapped. A microcontroller, connected downstream of integrated circuit 20 and not shown in FIG. 4, or a state machine with a simpler structure, if required, can read out these time signals just stored and decoded in logic and control unit 30. A clock signal can be supplied via terminals 33 to integrated circuit 20 or logic and control unit 30.

For further control of switching unit 25, said unit is connected to logic and control unit 30 and controls logic and control unit 30 with a control signal 38. The integrated circuit further has terminals 36, 37, via which logic and control unit 30 can be supplied with control signals SS1, SS2.

The indicator 106 shown in FIGS. 3 and 6 to 8 can also be an audible warning device such as a loudspeaker or a piezo buzzer or a combination of an optical and audible indicating device.

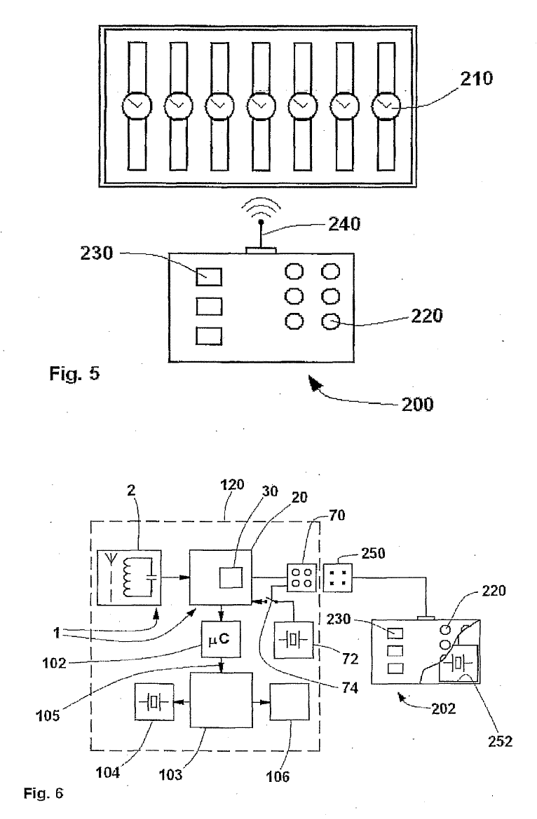

FIG. 5 shows a programming device 200, which is provided for simultaneous programming of a plurality of time signal receivers 210 made as radio-controlled wristwatches. Programming device 200 has several control buttons 220, 230, which are provided for setting the programming process or for setting the functions to be released in the time signal receivers. Programming device 200 has an antenna 240 for sending out a long-wave time signal or programming signal, so that a wireless programming or transmission of a time signal to time signal receiver 210 can be carried out.

FIG. 6 shows a programming device 202, which is provided for wired programming of a time signal receiver 120 made as a radio-controlled wrist watch. Programming device 202 has several control buttons 220, 230, which are provided for setting the programming process or for setting the functions to be released in the time signal receiver. Programming device 202 is equipped with a signal cable, which is equipped at the end side with a contact plug 250. The contact plug is formed for electrical coupling to a correspondingly made contact device 70 at time signal receiver 120 and enables the transmission of programming instructions and a programming clock signal from programming device 202 to time signal receiver 120.

Time signal receiver 120 has the same subassemblies as time signal receiver 100 shown in FIG. 3, but is equipped furthermore with an additional internal clock generator 72 and with contact device 70.

The programming clock signal is supplied by an oscillator 252 disposed in programming device 202 and then is fed into integrated circuit 20 in such a way that it can bring about the desired increase in the receivable data rate there and in microcontroller 102 connected downstream. Internal clock generator 72, provided for supplying the operating clock signal and made as a quartz oscillator, is connected to receiver 1 and in addition also to microcontroller 102 and supplies a basic clock frequency, which is divided down by a frequency divider (not shown) to the operating clock frequency. Internal clock generator 72 can be temporarily decoupled from receiver 1 by a switching device, shown symbolically as switch 74, during the programming process to avoid collision of the operating clock frequency with the programming clock frequency supplied by programming device 202.

The programming clock signal supplied by external oscillator 252, provided in programming device 202, can be variably adjustable with the use of a frequency divider (not shown) or output as a fixedly predefined programming clock frequency to time signal receiver 120.

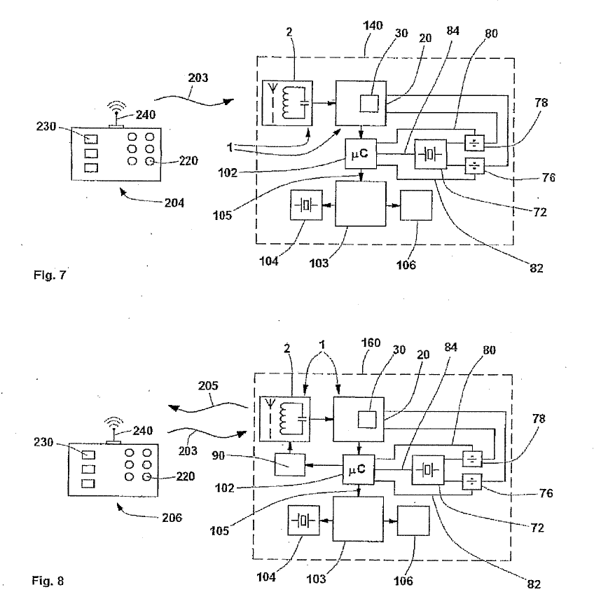

Programming device 204 shown in FIG. 7 is provided for wireless transmission of programming instructions and has an antenna 240, which makes possible the sending out of electromagnetic signals to time signal receiver 140 without a mechanical connection between programming device 204 and time signal receiver 140. Time signal receiver 140 is fitted out with an internal clock generator 72 formed as a quartz oscillator, which is provided for supplying a basic clock signal. Internal clock generator 72 is assigned two schematically shown frequency dividers 76 and 78, which have different divider ratios and thus can derive an operating clock frequency or a programming clock frequency from the basic clock frequency of integrated clock generator 72 and relay it to receiver 1.

Microcontroller 102 is connected via a control line 84 to integrated clock generator 72 and therewith enables activation or deactivation of internal clock generator 72. Deactivation of internal clock generator 72 can be provided when programming device 204 wirelessly transmits, apart from programming instructions, also an external clock signal, which can be coupled via antenna 2 into receiver 1 and into microcontroller 102.

If no corresponding programming clock signal is supplied by programming device 204, internal clock generator 72 remains activated during the programming process. Upon arrival of an appropriate programming instruction, first frequency divider 76, configured to supply the operating clock signal, is deactivated by microcontroller 102 and second frequency divider 78, provided for supplying the programming clock signal, is activated. The higher programming clock frequency is provided thereby at receiver 1 and therefore also at microcontroller 102 and receiving of the programming instructions of programming device 204 can occur at a data rate that is higher than the data rate of the time signal.

Programming device 206 shown in FIG. 8 is provided for wireless transmission of programming instructions and has an antenna 240, which makes possible the sending out of electromagnetic signals to time signal receiver 160 without a mechanical connection between programming device 206 and time signal receiver 160. Programming device 206 is equipped with a control device (not shown) and memory means and with receiving means for the programming control signal.

Time signal receiver 160 is fitted out with an internal clock generator 72 formed as a quartz oscillator, which is provided for supplying a basic clock signal. Internal clock generator 72 is assigned two schematically shown frequency dividers 76 and 78, which have different divider ratios and thus can derive an operating clock frequency or a programming clock frequency from the basic clock frequency of integrated clock generator 72 and relay it to receiver 1.

Microcontroller 102 is connected via a control line 84 to integrated clock generator 72 and therewith enables activation or deactivation of internal clock generator 72. Deactivation of internal clock generator 72 can be provided when programming device 206 wirelessly transmits, apart from programming instructions, also an external clock signal, which can be coupled via antenna 2 into receiver 1 and into microcontroller 102.

If no corresponding programming clock signal is supplied by programming device 206, internal clock generator 72 remains activated during the programming process. Upon arrival of an appropriate programming instruction, first frequency divider 76, configured to supply the operating clock signal, is deactivated by microcontroller 102 and second frequency divider 78, provided for supplying the programming clock signal, is activated. The higher programming clock frequency is provided thereby at receiver 1 and therefore also at microcontroller 102 and receiving of the programming instructions of programming device 206 can occur at a data rate that is higher than the data rate of the time signal.

Microcontroller 102 is assigned control means 90, which are provided for controlling antenna 2 and which enable wireless transmission of a programming control signal, which can be supplied by microcontroller 102, to programming device 206. The transmission of the programming control signal as an electromagnetic wave is indicated by arrow 205. Programming device 206 is set up for receiving and processing of the programming control signal and therewith can bring about an increase or reduction in the data rate, with which the programming instructions are transmitted to time signal receiver 160, during and/or after a programming process. Preferably, the programming clock frequency is supplied by programming device 206, because this device can hold ready a higher variety of different programming clock frequencies for adjustment to the maximum data rate of the time signal receiver.

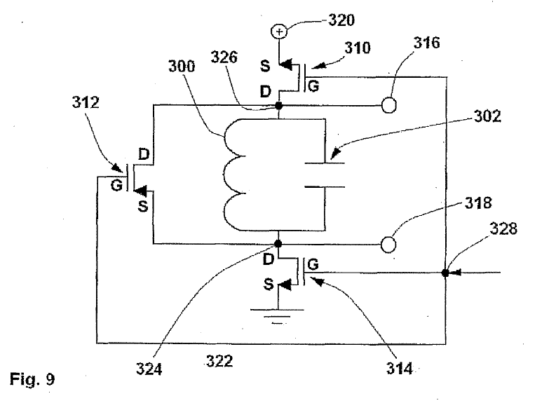

FIG. 9 shows an enlarged section of a region of receiver 2 according to FIG. 8, whereby control means 90, shown as a separate block in FIG. 8, can be represented at least substantially by the three MOS transistors 310, 312, and 314 and by the associated control lines. Integrated circuit 20 and control unit 30 of receiver 1 are not shown in FIG. 6 for reasons of simplicity. Connection points 316 and 318 for electric coupling to the integrated circuit and the control unit are shown, however.

Antenna 2 has a coil 300 and a capacitor 302, which are connected parallel to one another. In each case, connection points 316 and 318, which are provided for relaying a signal coupled inductively from outside by electromagnetic waves to the integrated circuit and to the control device, are coupled electrically at common nodal points 324, 326 of coil 300 and capacitor 302. Current terminals (source terminal S and drain terminal D) of PMOS transistor 312 are connected at nodal points 324 and 326; in a conducting state, said transistor is capable of short-circuiting nodal points 324 and 326 and therewith avoiding a postoscillation of the resonant circuit formed by coil 300 and capacitor 302.

A current terminal (drain terminal D) of NMOS transistor 314, whose other current terminal (source terminal S) is connected to a ground terminal 322, is connected moreover at nodal point 324. A current terminal (source terminal S) of NMOS transistor 310, whose other current terminal (drain terminal D) is connected to a voltage source, is connected at nodal point 326. The control terminals (gate terminals G) of all transistors 310, 312, 314 are joined at a common nodal point 328, at which a signal supplied by microcontroller 102 for controlling the transistors can be coupled. When the signal supplied by microcontroller 102 is at a logic low level, both NMOS transistors 310 and 314 are blocked, because no positive control voltage is applied between the associated control terminals G and current terminals S.

PMOS transistor 312 is released due to the low level of the control signal, i.e., in an electrically conductive manner, and can therewith reduce a voltage difference between nodal points 324 and 326, so that a postoscillation of the resonant circuit comprising coil 300 and capacitor 302 is prevented. During application of a logic high level at NMOS transistors 310 and 314, therefore a control voltage that is greater than a threshold voltage of NMOS transistors 310, 314, a positive control voltage is present between control terminals G of NMOS transistors 310, 314 and the specifically assigned current terminals S, so that the two NMOS transistors 310, 314 are connected in a conductive manner. Thereby, typically only for short time, the electric voltage, applied between the voltage source and ground terminal 322, is applied at coil 300 and at capacitor 302 and causes coil 300 to emit an electromagnetic pulse. This electromagnetic pulse can be received by programming device 206, shown in FIG. 5, as a programming control signal.

Depending on the type of the predefinable protocol for the programming control signal, a pulse sequence can be transmitted wirelessly to programming device 206 by application of a sequence of logic low and high signals at the control device. The pulse sequence can be evaluated in programming device 206 and assessed as confirmation of a successfully completed programming process. Next, depending on incoming programming control signals, an increase or reduction of a programming clock frequency and a data rate for programming instructions can be realized.

In the present invention, a combination of the aforementioned aspects can be provided for the devices or for the method. In an embodiment, which is not shown, a wirelessly programmable time signal receiver is provided, which can be programmed with an internally or externally supplied programming clock frequency and during and/or after the programming process with a programming control signal that can be transmitted wirelessly to the programming device.

In another embodiment, which is not shown, a notification device with a programmable time signal receiver is provided, which is integrated into a household appliance made as a smoke alarm and which can be programmed alternatively both wired via a corresponding contact device and also wirelessly with the use of the time signal or a programming signal, whereby the programming occurs using a programming clock frequency which is increased compared with the operating clock frequency of the time signal receiver, and at the end of the programming process a programming control signal is transmitted to the programming device, which confirms the complete transmission of all user data predefined by the programming device to the memory means of the notification device.

In a preferred method, wireless transmission of the programming instructions is provided. During the programming process, the time signal receiver is supplied with an individually adjusted programming clock frequency, which depends on the correct arrival of the programming controls signals, and with a data rate, adjusted thereto, for the programming instructions, and user-specific data are transmitted during the programming. Therefore, a notification device is initialized by this method in such a way that it is in a position to output regional warning notifications only when the region that is programmed in is to be covered by the corresponding warning signal.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A notification device comprising:
a time signal receiver that comprises:
a receiver for receiving an electromagnetic time signal; and
a processor for processing the time signal,
a signal output device assigned to the time signal receiver for generating a warning signal,
wherein the time signal receiver and/or the signal output device is/are set up to generate a warning signal when there is at least one piece of additional information transmitted with a time signal.

2. The notification device according to claim 1, wherein at least one selection criterion provided for blocking or releasing control of the signal output device is stored in the time signal receiver and/or in the signal output device.

3. The notification device according to claim 1, wherein the receiver and/or processor are assigned a memory that is configured for temporary storage of the selection criterion.

4. The notification device according to claim 3, wherein the receiver and/or processor are set up to derive programming instructions, in particular an encoded selection criterion, from the time signal and/or from a wirelessly transmitted programming signal and to store the programming instructions in the memory.

5. The notification device according to claim 1, wherein the time signal receiver has a frequency switch that supplies at least two different clock frequencies for the time signal receiver.

6. The notification device according to claim 1, further comprising a controller, which is configured to output a programming control signal supplied by the receiver and/or by the processor and/or by the memory.

7. A household appliance with at least one functional unit for providing a useful function, the household appliance having a notification device that comprises:
a time signal receiver that comprises:
a receiver for receiving an electromagnetic time signal; and
a processor for processing the time signal,
a signal output device assigned to the time signal receiver for generating a warning signal,
wherein the time signal receiver and/or the signal output device is/are set up to generate a warning signal when there is at least one piece of additional information transmitted with a time signal.

8. A method for programming a notification device, the method comprising:
providing at least one programming instruction to a time signal receiver in the notification device via a programming device;
decoding the programming instruction by a receiver and/or by a processor of the notification device; and
storing the programming instruction, which is designated for execution in the receiver and/or in the processor, in a memory of the notification device.

9. The method according to claim 8, wherein the programming instructions are transmitted wirelessly by the programming device to the notification device, particularly to the time signal receiver.

10. The method according to claim 8, wherein the programming instructions are supplied at a data rate that is selected higher than the data rate of a time signal, wherein the time signal receiver is supplied with a programming clock frequency, which is adjusted to the data rate and is selected higher than an internal operating clock frequency of the time signal receiver.

11. The method according to claim 8, wherein during and/or after the programming process, a programming control signal is output by the time signal receiver to the programming device.

12. The household appliance according to claim 12, wherein the household appliance is a smoke alarm.
